(19) United States
(12) Patent Application Publication
(10) Pub. No.: US 2016/0116386 A1
(43) Pub. Date: Apr. 28, 2016

(54) MAGNETIC SEPARATION RACK ASSEMBLY

(71) Applicant: Bel-Art Products, Wayne, NJ (US)

(72) Inventor: Miguel A. Puig, Sterling Forest, NY (US)

(21) Appl. No.: 14/918,735

(22) Filed: Oct. 21, 2015

Related U.S. Application Data
(60) Provisional application No. 62/068,150, filed on Oct. 24, 2014.

(51) Int. Cl. G01N 1/40; B03C 1/02; B01L 9/06

(52) U.S. Cl. CPC G01N 1/4077; B01L 9/06; B03C 1/02; G01N 2001/4038; B01L 2200/0631; B03C 2201/18

(57) ABSTRACT

The present invention provides a magnetic separation assembly. The assembly includes a base having at least one opening. The assembly also includes a holder positioned securely inside the at least one opening of the base. The holder includes a magnet. The assembly also includes a retainer securely inserted into the holder.

### RELATED APPLICATIONS

This application claims the benefit of U.S. Provisional Application Ser. No. 62/068,150 filed Oct. 24, 2014, entitled, “Magnetic Separation Rack Assembly”, the entire content of which is incorporated herein by reference.

### FIELD OF THE INVENTION

The present invention relates to field of separation racks, and more particularly, to magnetic separation rack assembly for use in processing magnetic particles.

### BACKGROUND OF THE INVENTION

Biological laboratories often require separation of particles in a solution. Target particles, such as proteins and the like, are separated from a solution by a technique known as magnetic separation. Magnetic separation is a process in which magnetically susceptible material is extracted from a mixture using a magnetic force.

Many magnetic rack assemblies exist today that provide the magnetic separation by separating magnetic or magnetizable particles from the mixture by a magnetic field produced by one more permanent magnets. Such magnetic rack assemblies include a rack having a permanent magnet to provide for insertion of the test tube. As the test tube having the mixture is inserted into rack, the particles inside the mixture are attracted to the permanent magnet and remove themselves from the mixture but remain within an inside the wall of the test tube.

In such magnetic rack assemblies in order to utilize a solution in the mixture for laboratory purposes, many times the test tube is removed from the rack, which results in particles mixing into the solution. In some cases, a pipette or a similar assembly is used to remove the solution from the mixture in the test tube. In yet other cases, the rack is tilted in order to remove the solution from the mixture in the test tube. However, in these magnetic rack assemblies, in order to securely remove the solution from the mixture without the particles, the test tube needs to remain within the rack.

Thus, there is a need in the art to provide for a magnetic separation rack in which the test tube is removable from the rack. There is also a need in the art to provide for the magnetic separation rack in which the test tube is securely placed within the rack with respect to the magnet.

### SUMMARY OF THE INVENTION

The present invention overcomes the disadvantages of the current magnetic separation racks by providing a magnetic separation rack assembly, which is designed to have a test tube removable from the magnetic separation rack, details of which are provided herein below.

According to one aspect of the invention, there is provided a magnetic separation rack assembly, which includes a base having one or more openings for insertion of a holder such as a test tube holder. In one embodiment, the holder includes a magnet, which separates the particles from the solution within the mixture of the container upon insertion of a container such as a test tube inside the holder. In one embodiment, the holder is detachable from the base. As such, the container within the holder is removable from the rack assembly.

In one embodiment, the holder includes a retainer to securely hold the container in an upright position with respect to the magnet. As such, movement of the base and holder does not cause the container to move within the holder, thus keeping the container stable within the holder. This results in retaining of the separation of the particles from the solution in the container.

In one embodiment, the retainer also functions to provide the flexibility to move the container within the holder in order to place the container in a desired position with respect to the magnet. The container may be moved up or down within the holder with respect to the magnet and the retainer securely holds the container in the desired position. As such, the container may be moved within the holder in the position yet retaining the separation of the particles from the solution.

### BRIEF DESCRIPTION OF THE DRAWINGS

FIG. 1 is a schematic view of a magnetic separation rack assembly in accordance with an embodiment of the present application.

FIG. 2 is a cross-sectional view of a holder of the magnetic separation rack assembly of FIG. 1 in accordance with an embodiment of the present application.

FIG. 3 is a cross-sectional inside view of a holder of the magnetic separation rack assembly of FIG. 1 and a container in accordance with an embodiment of the present application.

FIG. 4 is a cross-sectional inside view of a holder of the magnetic separation rack assembly of FIG. 1 and a container inside the holder in accordance with an embodiment of the present application.

FIG. 5 is a cross-sectional inside view of a holder of the magnetic separation rack assembly of FIG. 1 and a container inside the holder in accordance with another embodiment of the present application.

FIG. 6 is a cross-sectional inside view of a holder of the magnetic separation rack assembly of FIG. 1 and a container inside the holder in accordance with another embodiment of the present application.

FIG. 7 is a schematic view of a complete assemblage of magnetic separation rack assembly of FIG. 1 in accordance with an embodiment of the present application.

### DETAILED DESCRIPTION OF THE INVENTION

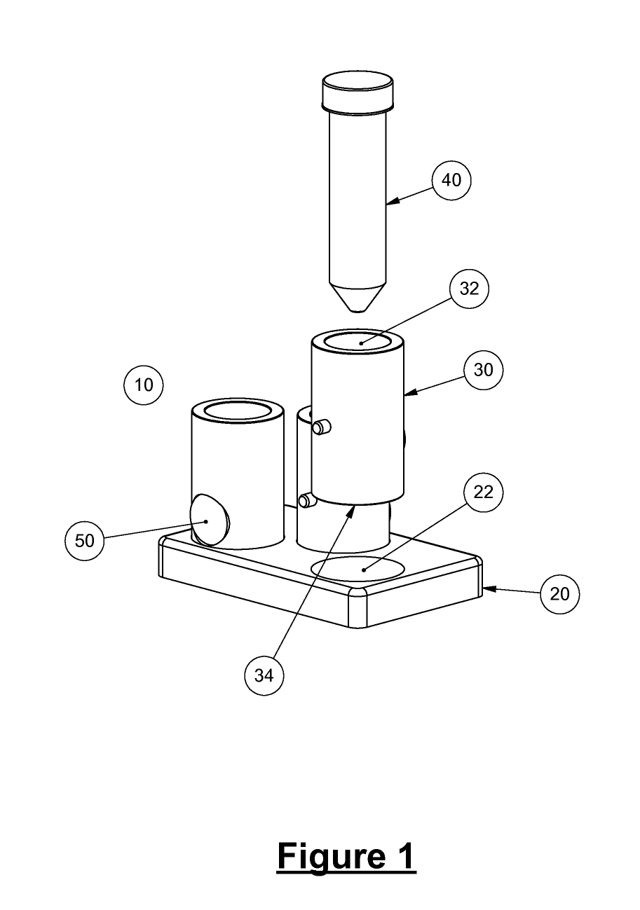

Referring to FIG. 1, there is shown a magnetic separation rack assembly 10 having a base 20, a holder 30 such as test tube holder and a container 40 in accordance with an embodiment of the present invention. Although, FIG. 1 illustrates the container 40 to be a test tube, one of ordinary skill in the art would appreciate that the container 40 may be a cylinder, a beaker, a flask or other commonly used laboratory equipment for holding solutions. In one embodiment, the test tube 40 as shown is centrifuge tube used for isolating and separating suspensions as will be described in greater detail below.

In one embodiment, the base 20 has a flat planar surface having one or more openings 22 shaped and sized to accommodate for insertion of the holder 30. In one embodiment, the holder 30 is removable from the base 20. Although, FIG. 1 shows the opening 22 to be substantially circular in shape, one of ordinary skill in the art would appreciate that the opening 22 may be of other shapes such as rectangular, square, oval etc. The holder 30 may have a substantially cylindrical body preferably made of plastic or steel or combination of both materials. Also, FIG. 1 illustrates the base 20 having three openings 22 for placement of three holders 30, however, one of ordinary skill in the art would appreciate that the base 20 may have more or less than three openings 22 for placement of more or less than three holders 30.

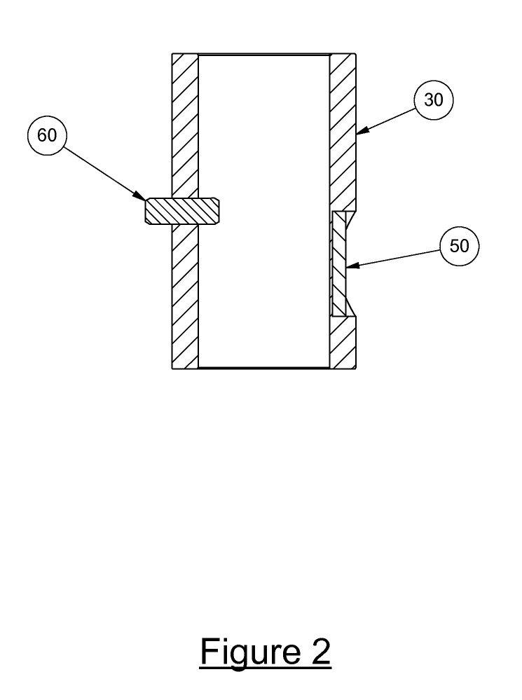

In one embodiment, a top end of the holder 30 includes an opening 32 shaped and sized to accommodate for insertion of the test tube 40. Although, FIG. 1 shows the opening 32 to be substantially circular in shape, one of ordinary skill in the art would appreciate that the opening 22 may be of other shapes such as rectangular, square, oval etc. In one embodiment, a bottom end of the holder 30 also includes an opening 34. Referring to FIG. 2, there is illustrated a cross-sectional view of the holder 30 in accordance with an embodiment of the present invention. As shown, a magnet 50 is embedded within the holder 30. In one embodiment, a recess is made within the holder 30 and the magnet 50 is securely placed into the recess within the holder 30. The magnet 50 may be glued into the recess of the holder. The magnet 50 may be pressed fitted into the recess of the holder. In one embodiment, the magnet 50 is permanently attached to the holder 30.

Also, shown in FIG. 2 is a retainer 60 securely inserted into the holder 30 such that the retainer 60 is positioned substantially perpendicular to the holder 30. In one embodiment, a hole is made into the holder 30 and the retainer 60 is placed inside the hole. In one embodiment, one portion of the retainer 60 projects outward from the holder 30 and other portion of the retainer 60 projects inside the holder 30. In one embodiment, the retainer 60 functions to accommodate various shapes and sizes of the test tube 40. In one embodiment, the retainer 60 functions to tighten or loosen the test tube 40 in order to accommodate movement of the test tube 40 up and down within the holder 30. In one embodiment, the retainer 60 is permanently attached to the holder 30. In one embodiment, the retainer 60 functions to securely hold the test tube 40 within the holder 30 with respect to the magnet 50 as will be described in greater detail below.

In one example, the retainer 60 is a screw such that threaded portion of the screw projects inside the holder 30 and head portion of the screw projects outward from the holder 30. In example, the retainer 60 is a spring loaded or a compressible material plunger that presses against the test tube 40 keeping the test tube 40 in a position (such as standing straight position) as desired.

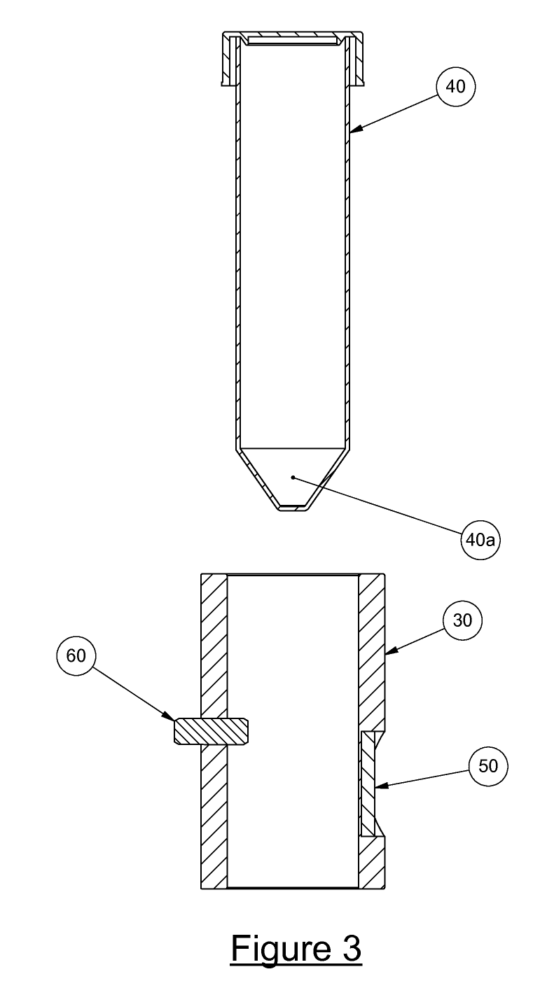

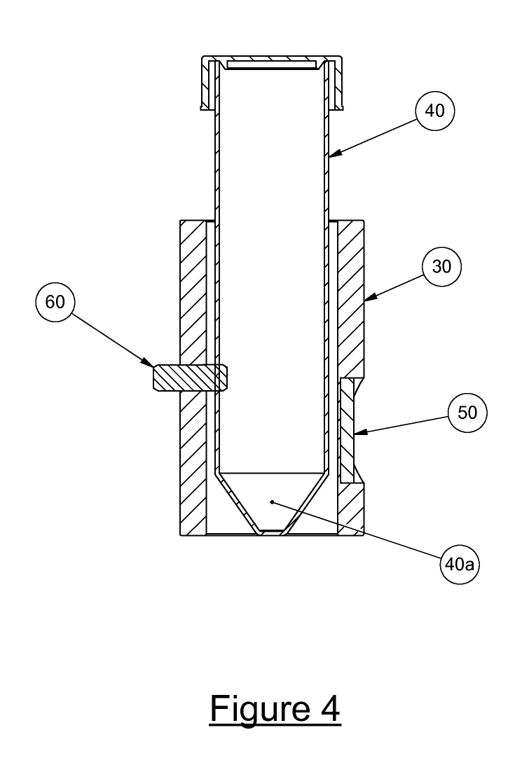

FIG. 3 shows a cross-sectional inside view of the holder 30 with the test tube 40 being inserted inside the holder 30. As the test tube 40 is inserted inside the holder, the retainer 60 functions to firmly hold the test tube 40 in an upright position as shown in FIGS. 4, 5, and 6. Also, the retainer 60 functions to place the test tube 40 within the holder 30 with respect to the magnet 50. Specifically, the retainer 60 holds the test tube 40 against the magnet 50. As such, even by moving the base 20 and/or the holder 30, (or even by turning the base 20 and/or the holder 30 upside down) the test tube 40 does not move (or even fallout from the base 20 and/or the holder 30). Accordingly, the test tube 40 remains securely stable within the holder 30 in an upright position against the magnet 50. This results in retaining the separation of the particles from the solution in the test tube 40.

FIG. 4 illustrates the test tube 40 securely placed within the holder 30 by the retainer 60 such that conical portion 40a of the test tube 40 rests on the bottom end of the holder 30. As such, the particles (not shown) are separated from the solution in the mixture are attracted to the magnet 50 and thus retain in a location inside portion of the test tube 40, which is above the conical portion 40a closest to the magnet 50. In one embodiment, the holder 30 with the test tube 40 illustrated in FIG. 4 is not placed on the base 20. In another embodiment, the holder 30 with the test tube 40 illustrated in FIG. 4 is placed on the base 20.

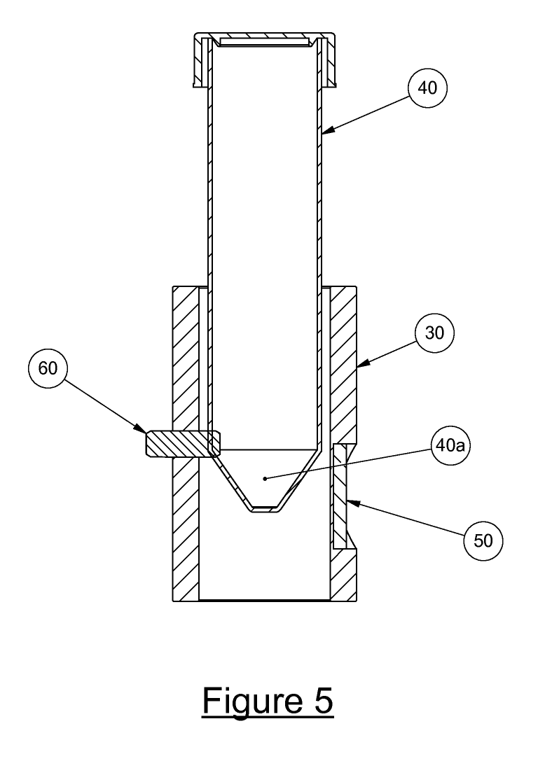

In one embodiment, the retainer 60 provides a flexibility to securely hold the test tube 40 within the holder 30 with respect to the magnet even when the test tube 40 is moved within the holder 30. In one embodiment, the test tube 40 is moved within the holder 30 in a desired position with respect to the magnet 50. In one embodiment, as shown in FIG. 5, the test tube 40 is moved upwards within the holder 30. In this embodiment, the conical portion 40a of the test tube 40 is placed above the bottom portion end of the holder 30. As such, the retainer 60 not only functions to retain the test tube 40 in the upright position but also positions the test tube 40 with respect to the magnet 50 in order to retain the separation of the particles from the solution in a location needed or desired in the test tube 40. In this embodiment, the location is at the conical portion 40a of the test tube 40. In one embodiment, the holder 30 with the test tube 40 illustrated in FIG. 5 is not placed on the base 20. In another embodiment, the holder 30 with the test tube 40 illustrated in FIG. 5 is placed on the base 20.

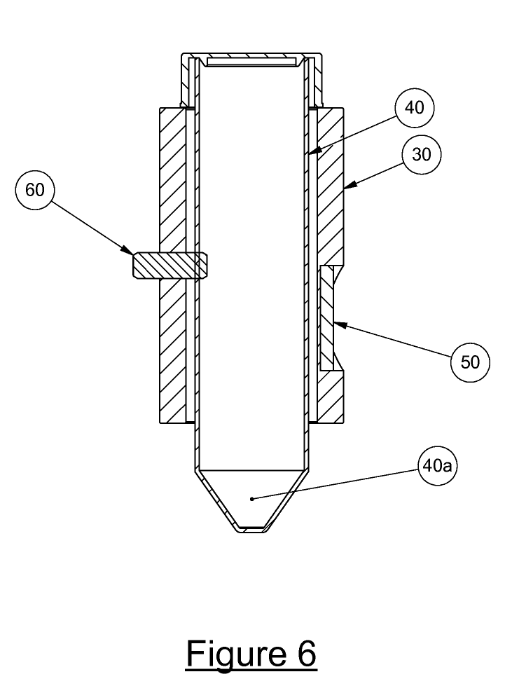

In another embodiment, the test tube 40 is moved downwards beyond the opening 34 within the holder 30 as shown in FIG. 6. As such, in this embodiment, the holder 30 with the test tube is not placed on the base 20. Similarly, the retainer 60 not only functions to retain the test tube 40 in the upright position but also position the test tube 40 with respect to the magnet 50 in a location as needed or desired in order to retain the separation of the particles from the solution. In this embodiment, the location is at above the conical portion 40a and towards a center of the test tube 40.

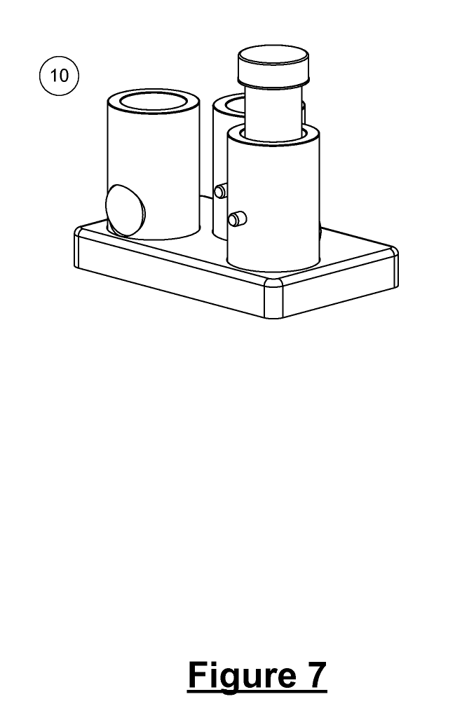

FIG. 7 illustrates a complete assemblage of the magnetic separation rack assembly 10 with the holders 30 having the test tubes 40 placed on the base 20.

It will be appreciated by those skilled in the art that changes could be made to the embodiments described above without departing from the broad inventive concept thereof. It will be understood, therefore, that this invention is not limited to the particular embodiments disclosed, but is intended to cover modifications within the spirit and scope of the present invention as defined by the appended claims.

1. A magnetic separation assembly comprising:
a base comprising at least one opening; and
a holder positioned securely inside the at least one opening of the base, wherein the holder comprises a magnet.

2. The magnetic separation assembly of claim 1, wherein the holder is detachable from the base.

3. The magnetic separation assembly of claim 1 wherein the magnet is permanently attached to the holder.

4. The magnetic separation assembly of claim 1 wherein the magnet is embedded within the holder.

5. The magnetic separation assembly of claim 1 further comprising a retainer securely inserted into the holder.

6. The magnetic separation assembly of claim 5 wherein the holder comprises a recess and the retainer is inserted into the recess.

7. The magnetic separation assembly of claim 5 wherein one portion of the retainer projects outward from the holder and other portion of the retainer projects inside the holder.

8. The magnetic separation assembly of claim 5 wherein the retainer is positioned substantially perpendicular to the holder.

9. The magnetic separation assembly of claim 5 wherein the retainer comprises a spring plunger.

10. The magnetic separation assembly of claim 5, wherein the retainer securely holds a container in the holder in an upright position within the holder.

11. The magnetic separation assembly of claim 10, wherein the retainer positions the container with respect to the magnet within the holder.

12. The magnetic separation assembly of claim 10 wherein container comprises a mixture of solution and particles and the retainer functions to retain the particles from the solution in the container.
